(19) United States
(12) Patent Application Publication
(10) Pub. No.: US 2005/0232115 A1
(43) Pub. Date: Oct. 20, 2005

(54) Hologram memory medium, apparatus and method of recording and/or reproducing information with respect to the hologram memory medium

(75) Inventors: Ikuo Aoki, Yokohama (JP); Yoshitaka Takahashi, Yokohama (JP)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Suwon-si (KR)

(21) Appl. No.: 11/081,721

(22) Filed: Mar. 17, 2005

(30) Foreign Application Priority Data
Apr. 14, 2004 (JP) 2004-118856
Oct. 5, 2004 (KR) 2004-79209

(51) Int. Cl. G11B 7/00

(52) U.S. Cl. 369/103

(57) ABSTRACT

A method of recording/reproducing information on/from a card-shaped hologram memory medium is provided in which an information recording/reproducing optical system can be conveniently controlled to increase a recording capacity of the card-shaped hologram memory medium. In the method, pieces of information are sequentially recorded in a data recording/reproducing area of the card shaped hologram memory medium along a predetermined route, while maintaining a predetermined distance between pieces of information.

### CROSS-REFERENCE TO RELATED APPLICATIONS

This application claims all benefits of Japanese Patent Application No. 2004-118856, filed on Apr. 14, 2004, in the Japanese Intellectual Property Office, and Korean Patent Application No. 2004-79209, filed on Oct. 5, 2004, in the Korean Intellectual Property Office, the disclosures of which are incorporated herein in their entirety by reference.

### BACKGROUND OF THE INVENTION

1. Field of the Invention

The present invention relates to a memory medium, and, more particularly, to a method of recording and/or reproducing information with respect to a hologram memory medium, in which the information is recorded as interference fringes by using an object beam and a reference beam.

2. Related Art

Recently, a rewritable optical disk of a phase shift type or an optical magnetic type is widely used as an information recording medium. In order to increase the recording density of such an optical disk, reducing the diameter of a beam spot and the distance between adjacent tracks or adjacent bits is required.

Although the recording density of an optical disk has been increased, the recording density of such an optical disk is physically limited by a diffraction limit of a beam, because data is recorded on a surface. Accordingly, a three-dimensional multi-recording including a depth direction is required to increase the recording density of an optical disk.

Therefore, a hologram memory medium having a large capacity due to a three-dimensional multi-recording region and a high speed due to a two-dimensional recording/reproducing method has attracted public attention as a next generation of computer file memory. Such a hologram memory medium may be formed by inserting a recording layer, which is formed of a photopolymer, between two sheets of glass. In order to record data on such a hologram memory medium, an object beam corresponding to data to be recorded and a reference beam are irradiated to the hologram memory medium to form interference fringes or interference patterns of the object beam and the reference beam. In order to reproduce data from the hologram memory medium, the reference beam is irradiated to the interference fringes to extract optical data corresponding to the recorded data.

In addition, hologram memory media having a cube shape and a card shape are provided. For example, Japanese Laid-open Patent No. 2000-67204 discloses a card shaped hologram memory including multiple recording layers on which waveguides are recorded to increase a recording capacity.

However, when recording/reproducing data on/from such a hologram memory medium, data is recorded on or reproduced from a data recording/reproducing area (or data area) on the hologram memory medium in a horizontal direction along a reference line, also known as a recording route, as shown in FIG. 1. At the end of the reference line, the recording or the reproducing is stopped to move to an adjacent reference line, and then the recording or the reproducing of data is repeated in the horizontal direction along the adjacent reference line. However, such a method stops the recording or the reproducing of data at the ends of the reference lines. As a result, the operation continuity cannot be secured. Furthermore, the control of a data recording/reproducing optical system becomes complicated.

### SUMMARY OF THE INVENTION

Accordingly, the present invention advantageously provides methods of recording/reproducing information on/from a hologram memory medium in which a recording/reproducing optical system can be conveniently controlled to increase a recording capacity of the hologram memory medium.

According to an aspect of the present invention, a method of recording information on a card or rectangular shaped hologram memory medium, comprises sequentially recording information on a data recording/reproducing area of the card shaped hologram memory medium along a predetermined route, while maintaining a predetermined distance between stripes of information.

Accordingly, the information can be continuously recorded on the card shaped hologram memory medium. In addition, the information can be continuously reproduced without operating an optical system, such as an optical pickup, unnecessarily.

The predetermined route may be formed in a spiral shape that spans the entire data recording/reproducing area of the card shaped hologram memory medium. Since the predetermined route is formed in the spiral shape, the data recording/reproducing area of the card shaped hologram memory medium can be effectively used, and the information may be continuously recorded in the data recording/reproducing area of the card shaped hologram memory medium.

The information recorded in the data recording/reproducing area of the card shaped hologram memory medium may be sequentially recorded from a central portion to a circumference or periphery of the card shaped hologram memory medium or from the circumference or periphery to the central portion of the card shaped hologram memory medium.

Accordingly, the data recording/reproducing area of the card shaped hologram memory medium can be effectively used, while continuously recording the information without operating an optical system unnecessarily.

Alternatively, the predetermined route may be formed in a continuous zig-zag shape that spans the entire data recording/reproducing area of the card shaped hologram memory medium, by having a plurality of reference lines that are parallel to one another and connecting the ends of each reference lines with the start portions of the following reference lines.

The information recorded on the data recording/reproducing area of the card shaped hologram memory medium may be sequentially recorded from an opened end of a reference line to an opened end of another reference line.

Accordingly, the data recording/reproducing area of the card shaped hologram memory medium can be effectively used, while continuously recording the information without operating an optical system unnecessarily.

A recording shape adjacent to a portion of converting a recording direction is a curve. Accordingly, a servo following property of an optical system, such as an optical pickup, may be sufficiently secured even in a portion of converting the recording direction.

According to an aspect of the present invention, the information may be recorded utilizing a two-dimensional shift multi-recording method. Accordingly, a recording capacity of the card-shaped hologram memory medium may be increased. When the information is recorded utilizing a two-dimensional shift multi-recording method, the distance between the parallel reference lines, which are formed in a spiral shape, is the same as a shift amount of the two-dimensional shift multi-recording. Accordingly, the information may be continuously recorded on the card shaped hologram memory medium, while increasing a recording capacity of the card shaped hologram memory medium, and without operating an optical system unnecessarily.

The present invention is more specifically described in the following paragraphs by reference to the drawings attached only by way of example.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the invention are limited only by the terms of the appended claims. The following represents brief descriptions of the drawings, wherein:

FIG. 1 illustrates a conventional method of recording information on a hologram memory medium useful in gaining a more thorough appreciation of the present invention;

FIG. 2 illustrates a method of recording/reproducing information on/from a data area of a card shaped hologram memory medium along a recording (reproducing) route in a spiral pattern according to a first embodiment of the present invention;

FIG. 3 illustrates an adjacent distance according to the first embodiment of the present invention;

FIG. 4 illustrates example interference fringes recorded in a spiral pattern according to the first embodiment of the present invention;

FIG. 5 illustrates a method of recording/reproducing information on/from a data area of a card shaped hologram memory medium along a recording (reproducing) route in a continuous zig-zag pattern according to a second embodiment of the present invention;

FIG. 6 illustrates an adjacent distance according to the second embodiment of the present invention;

FIG. 7 illustrates example interference fringes according to the second embodiment of the present invention;

FIG. 8 illustrates an example hologram memory medium according to an embodiment of the present invention;

FIG. 9 is a block diagram of an example information recording/reproducing apparatus according to an embodiment of the present invention;

FIG. 10 illustrates an example optical system according to an embodiment of the present invention; and

FIG. 11 is a flowchart illustrating a method of recording/reproducing information on/from a hologram memory medium according to an embodiment of the present invention.

### DETAILED DESCRIPTION OF THE EMBODIMENTS

The present invention is applicable for use with all types of memory or computer-readable media, hologram memory media, data recording/reproducing apparatuses and computer systems implemented methods described according to various embodiments of the present invention. However, for the sake of simplicity, discussions will concentrate mainly on exemplary use of a hologram memory media having a card shape or a rectangular shape, although the scope of the present invention is not limited thereto.

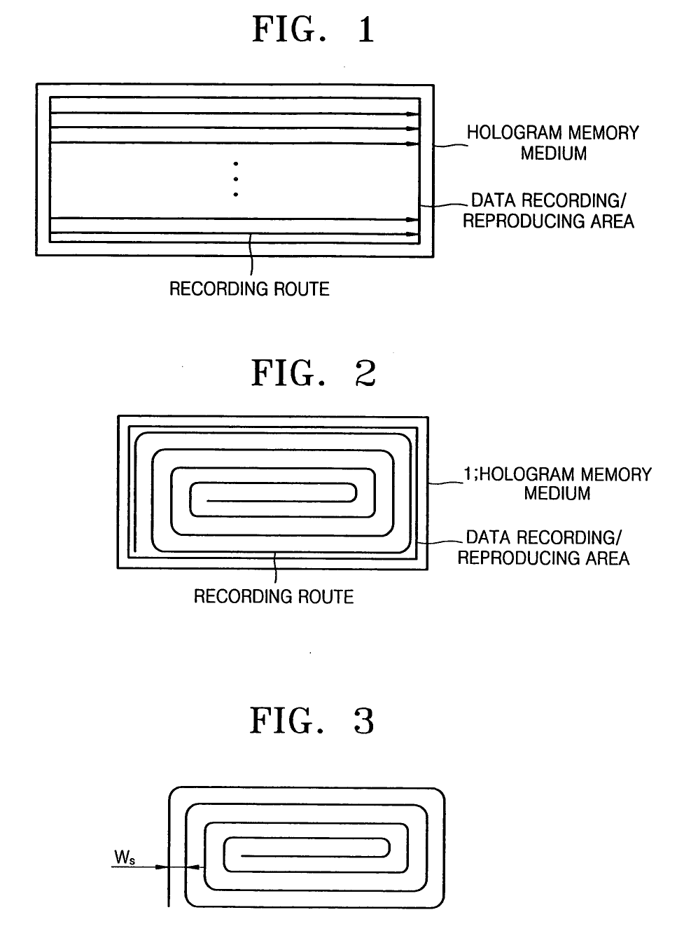

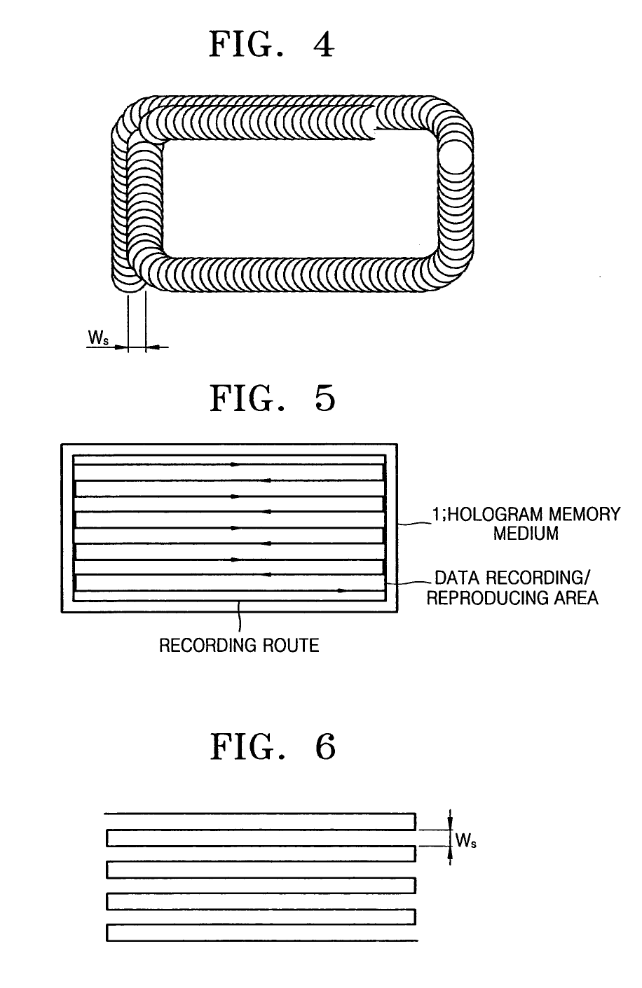

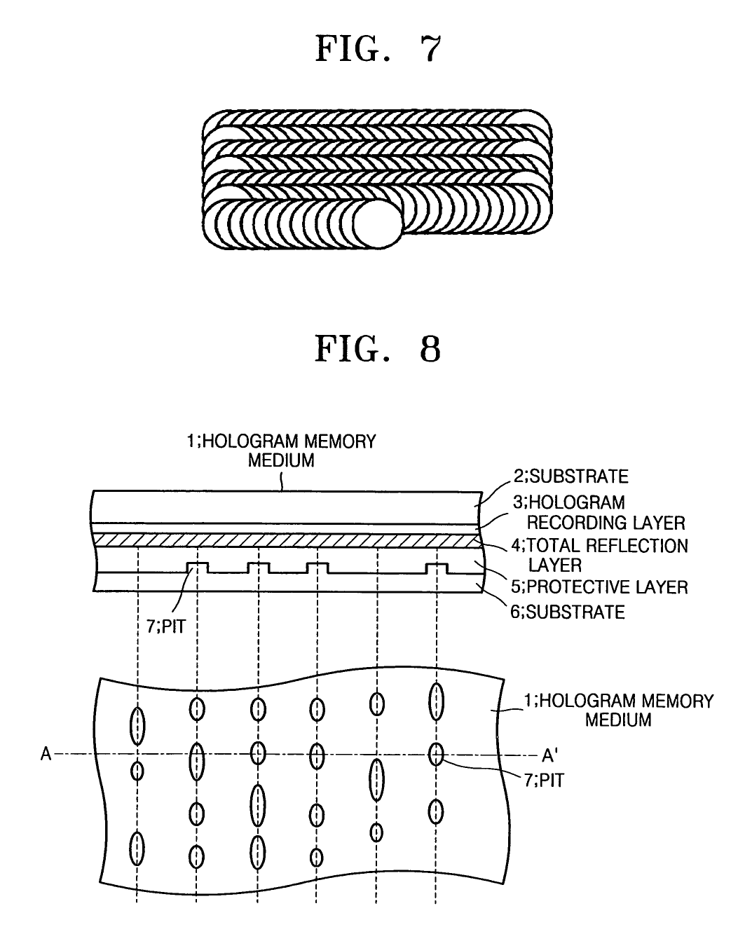

Attention now is directed to the drawings and particularly to FIGS. 2 through 7, in which hologram memory media having information recorded by methods of recording information such as video data, audio data, audio/visual (AV) data, computer files or meta information according to various embodiments of the present invention. Specifically, FIG. 2 illustrates a method of recording/reproducing information on/from a data area of a card shaped hologram memory medium along a recording (reproducing) route in a spiral or concentric pattern according to a first embodiment of the present invention. FIGS. 3-4 illustrate an example distance Ws between parallel reference lines established by an interference pattern which is a series of interference fringes that span the entire data area of the hologram memory medium, as shown in FIG. 2. FIG. 5 illustrates another method of recording/reproducing information on/from a data area of a card shaped hologram memory medium along a recording (reproducing) route in a continuous zig-zag pattern according to a second embodiment of the present invention. FIGS. 6-7 illustrate an example distance Ws between parallel reference lines established by an interference pattern which is a series of interference fringes that span the entire data area of the hologram memory medium, as shown in FIG. 5. FIG. 8 illustrates a sectional view of a hologram memory medium having servo information i.e., location determination information, recorded thereon which is arranged on a surface facing a surface having a data area.

In one example embodiment of the present invention, an interference pattern which is a series of interference fringes recorded on the hologram memory medium is formed in a spiral shape, as shown in FIGS. 2 through 4. Such interference fringes are recorded on the hologram memory medium due to an interference between an object beam and a reference beam during a recording operation. As a result, information can be continuously recorded on or reproduced from the hologram memory medium, starting from a central portion extending to a circumference or periphery of the hologram memory medium, or vice versa, without interruption, i.e., stopping recording or reproducing at an end of a reference line, and restarting at a next, adjacent reference line. In another example embodiment of the present invention, an interference pattern of interference fringes is formed in a continuous zig-zag shape by connecting end portions of reference lines to start portions of following references lines, while arranging the reference lines in parallel to one another, as shown in FIGS. 5 through 7.

Referring to FIG. 8, a hologram memory medium 1 includes a substrate 2, a hologram recording layer 3, a total reflection layer 4, a protective layer 5, a coat layer (not shown), an adherence layer (not shown), and a substrate 6 having pits 7 in a concave shape or a convex shape. As shown in FIG. 8, the substrates 2 and 6 serve as bases of the hologram memory medium 1. The hologram recording layer 3 is formed of a photosensitive material, for example, a photo polymer, a photorefractive crystal or any other material having a high recording/reproducing efficiency and resolution. Such a material should allow for repeated recording and erasing of data without causing a deterioration of the high recording/reproducing efficiency and resolution characteristics. Information of an object beam is recorded as interference fringes on the hologram recording layer 3 by irradiating the object beam and a reference beam to the same location on the hologram memory medium 1.

The total reflection layer 4 reflects the object beam and the reference beam that are irradiated to the hologram recording layer 3 to prevent the transmission of the object beam and the reference beam to a surface facing a surface having a data recording/reproducing area. The protective layer 5 physically protects servo information, in other words, the pits 7, in a concave shape or a convex shape formed on the substrate 6 from the outside.

The pits 7 include servo information of an optical system, such as an optical pickup, which records or reproduces information. Accordingly, the servo information can be optically read from the substrate 6 of the hologram memory medium 1 so as to properly control the location of the optical system, i.e., the irradiation location of the object beam and the reference beam from the optical system.

The pit row shape is symmetrical with the recording shape of the interference fringes (interference stripes), which are recorded on the hologram memory medium. For example, when the interference fringes are formed in a spiral shape, the pit row is formed in a spiral shape symmetrical with the spiral shape of the interference stripes.

Referring to FIGS. 3 and 6, the distance W_{S} between the parallel reference lines is applied to a two-dimensional multi-recording method. Therefore, the distance Wₛ may be the same as a shift amount of the two-dimensional multi-recording method. Accordingly, the distance between the pit rows is the same of the distance WS between the reference lines. The examples of the interference stripes, which are recorded by the two-dimensional shift multi-recording method, are shown in FIGS. 4 and 7.

In addition, recording information corresponding to table of content (TOC) data of a compact disk (CD) or a DVD is recorded in a predetermined location of the data recording/reproducing area. Such recording information recorded in the data recording/reproducing area includes location information, in other words, address data, recorded in each data row as well as actual recording information. Accordingly, an access to a predetermined data row can be performed by using the information corresponding to the TOC data and the address data of each data row.

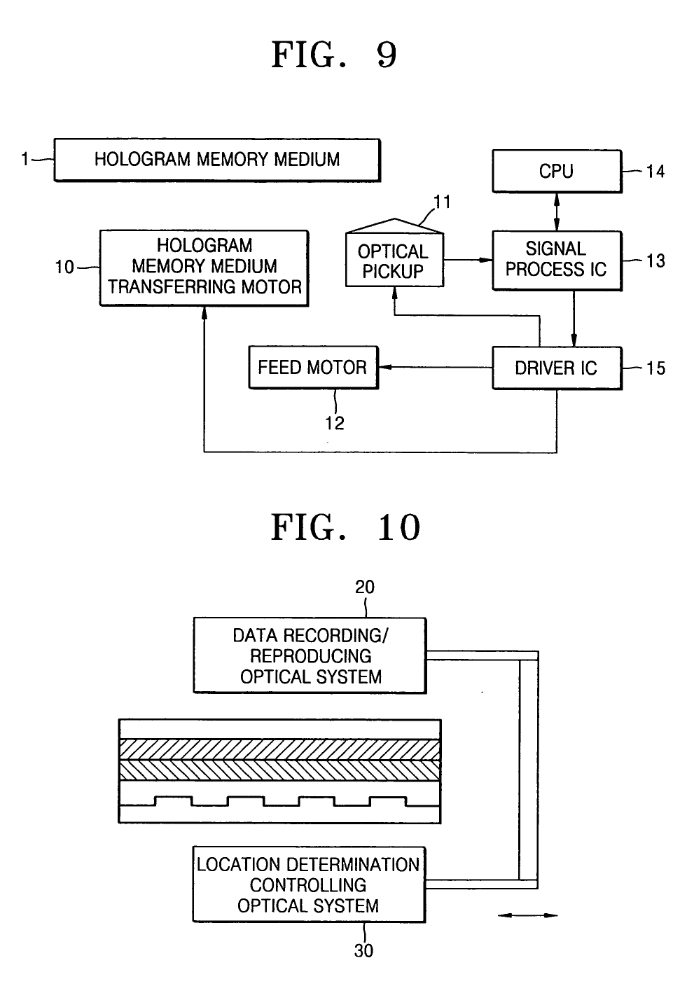

Turning now to FIG. 9, an information recording/reproducing apparatus for recording/reproducing information on/from a hologram memory medium according to an embodiment of the present invention is illustrated. As shown in FIG. 9, the information recording/reproducing apparatus includes a hologram memory medium transferring motor 10, an optical pickup 11, a feed motor 12, a signal process integrated circuit (IC) 13, a central processing unit (CPU) 14, and a driver integrated circuit (IC) 15.

The hologram memory medium transferring motor 10 transfers a hologram memory medium 1 in a different direction from a reference line to the same distance as the shift amount of a shift multi-recording, at the end portion of the reference line. In addition, the transfer of the hologram memory medium transferring motor 10 is controlled by the output of the driver IC 15.

The optical pickup 11 includes optical elements such as a laser light source, for example, a semiconductor laser, a collimator lens, an object lens, which is driven by a focus actuator or a tracking actuator, and a polarizing beam splitter, and a light receiving device.

The feed motor 12 moves the optical pickup 11 to a predetermined location along the hologram memory medium 1. More specifically, in a search operation, the feed motor 12 controls the location of the optical pickup 11 by using a driving voltage supplied from the driver IC 15. The driving voltage may be obtained, for example, based on the address data recorded on the hologram memory medium 1.

The signal process IC 13 generates a reproducing signal based on a return light quantity from the hologram memory medium 1 that is received by the light receiving device (not shown) in the optical pickup 11, while generating a focus error (FE) signal obtained by detecting a focus error of a radiation laser from the optical pickup 11 by an astigmatism method based on the return light quantity obtained by the light receiving device (not shown) in the optical pickup 11. Furthermore, the signal process IC 13 generates a track error (TE) signal obtained by detecting an error in the radiation laser from the optical pickup 11 in a reference line direction by a push-pull method. In addition, the signal process IC 13 generates a focus driving (FODRV) signal and a tracking driving (TRDRV) signal based on the FE and TE signals.

The CPU 14 controls the information recording/reproducing apparatus based on a control program stored in an internal memory such as a read only memory (ROM). According to an embodiment of the present invention, the CPU 14 controls various servo operations when recording information on the hologram memory medium 1. More specifically, the CPU 14 calculates a driving voltage of the feed motor 12 that is required to move the optical pickup 11 based on the present address data and the address data of a target location in a search operation, and supplies the driving voltage of the feed motor 12 to the driver IC 15 through the signal process IC 13.

The driver IC 15 inputs the focus driving (FODRV) signal or the tracking driving (TRDRV) signal that are generated in the signal process IC 13, and amplifies the input focus driving (FODRV) signal or tracking driving (TRDRV) signal to a predetermined size. Thereafter, the driver IC 15 supplies the amplified signal to a focus actuator or a tracking actuator.

Referring to FIG. 10, an example optical system, such as an optical pickup 11, shown in FIG. 9, for use in an information recording/reproducing apparatus according to an embodiment of the present invention is illustrated. As shown in FIG. 10, such an optical system includes a data recording/reproducing optical system 20 and a location determination controlling optical system 30. The data recording/reproducing optical system 20 records information in the data recording/reproducing area of the hologram memory medium 1 and reproduces information from the data recording/reproducing area of the hologram memory medium 1. The location determination controlling optical system 30 performs the location determination control of the object beam and the reference beam irradiated from the data recording/reproducing system 20 based on the servo information, when recording/reproducing information on/from the hologram memory medium 1. In addition, the data recording/reproducing optical system 20 and the location determination controlling optical system 30 are integrally formed. In such a situation, the location determination controlling optical system 30 transfers inconnection with the transfer of the data recording/reproducing optical system 20. However, the data recording/reproducing optical system 20 and the location determination controlling optical system 30 can also be physically separated. In such a situation, a control signal may be fed back from the location determination controlling optical system 30 to the data recording/reproducing optical system 20 so as to determine the location of the optical system.

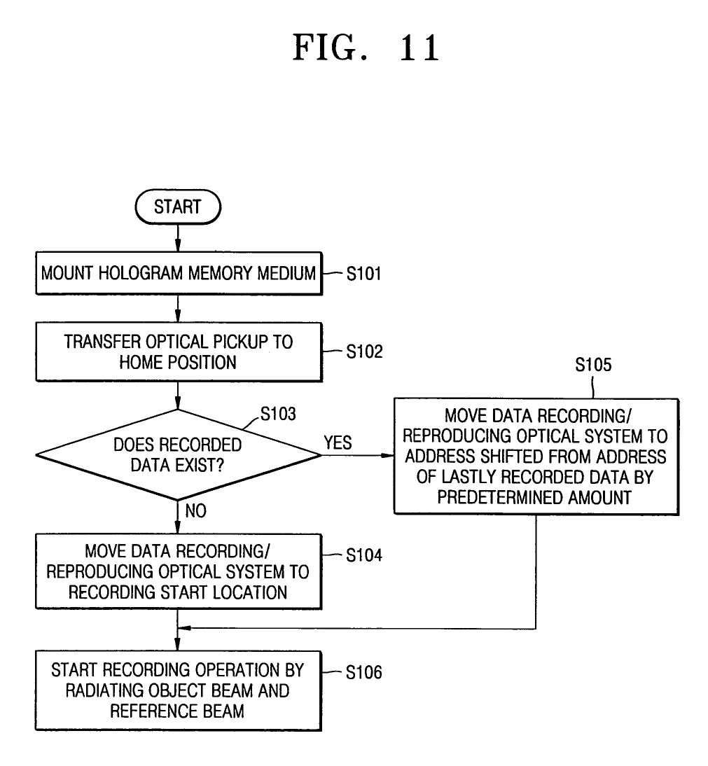

Turning now to FIG. 11, a method of recording information on a hologram memory medium utilizing an information recording/reproducing apparatus according to an embodiment of the present invention will now be described as follows.

When a hologram memory medium 1 is mounted in an information recording/reproducing apparatus in S101, a CPU 14 calculates a driving voltage of a feed motor 12 for transferring an optical pickup 11 based on address data from a location determination controlling optical system 30 in order to transfer the optical pickup 11 to a home position having recording information in the hologram memory medium 1 by supplying the driving voltage of the feed motor 12 to a driver IC 15 through a signal process IC 13, in S102.

Thereafter, the CPU 14 reads information corresponding to table of content (TOC) data, which is recorded around the home position, from a reproducing signal from the location determination controlling optical system 30 in order to determine whether the information is preliminarily recorded on the hologram memory medium 1, in S103. In the case where the information is not recorded on the hologram memory medium 1, the data recording/reproducing optical system 20 is transferred to a predetermined recording start location, in S104.

In the case where the information is recorded on the hologram memory medium 1, the data recording/reproducing optical system 20 is transferred to an address, which is obtained by shifting from the address of the last information by the amount corresponding to the shift amount of a shift multi-recording, in S105. When the recording/reproducing optical system 20 is transferred to a predetermined location, the data recording/reproducing optical system 20 radiates an object beam and a reference beam to the data recording/reproducing area of the hologram memory medium 1 to record predetermined information as interference stripes, in S106. Thereafter, the data recording/reproducing optical system 20 records information, while shifting by a predetermined amount based on location determination information, which is obtained from the location determination controlling optical system 30.

As described from the foregoing, the present invention advantageously provides methods of recording/reproducing information on/from a card type hologram memory medium, in which a data recording/reproducing area of the hologram memory medium can be effectively used, and information can be continuously recorded and reproduced. As a result, the operation continuity can be secured, and the control of a data recording/reproducing optical system can be simplified. In addition, such recording/reproducing methods can advantageously utilize two-dimensional shift multi-recording and reproducing techniques.

While there have been illustrated and described what are considered to be example embodiments of the present invention, it will be understood by those skilled in the art and as technology develops that various changes and modification may be made, and equivalents may be substituted for elements thereof without departing from the spirit and scope of the present invention. Many modifications may be made to adapt the teachings of the present invention to a particular situation without departing from the scope thereof. For example, the hologram memory medium can be formed in different sizes and shapes, such as square, cube, spherical and elliptical shape, as long as information can be continuously recorded on or reproduced from the hologram memory medium without interruption. In addition, the hologram memory medium can be a recordable medium formed of a photo-polymer, a multi-waveguide type medium or a rewritable medium formed of photorefractive crystals, such as LiNbO₃ (lithium niobate). Similarly, the CPU can be implemented as a chipset having firmware, or alternatively, a general or special purposed computer programmed to perform the methods as described with reference to FIGS. 2-7. Moreover, such a hologram memory medium can also have a wide range of applications, including multimedia computing, video-on demand, high-definition televisions, portable computing and consumer video. Accordingly, it is intended, therefore, that the present invention not be limited to the various example embodiments disclosed, but that the present invention includes all embodiments falling within the scope of the appended claims.

1. A method of recording information on a card shaped hologram memory, comprising sequentially recording information, in the form of interference fringes, on a data area of the card shaped hologram memory medium along a predetermined route, while maintaining a predetermined distance between interference fringes of information.

2. The method as claimed in claim 1, wherein the predetermined route is formed in a spiral shape that spans the entire data area of the hologram memory medium.

3. The method as claimed in claim 2, wherein the information recorded on the data area of the card shaped hologram memory medium is sequentially recorded from a central portion to a circumference of the card shaped hologram memory medium, or alternatively, from the circumference to the central portion of the card shaped hologram memory medium.

4. The method as claimed in claim 1, wherein the predetermined route is formed in a continuous zip-zag shape that spans the entire data area of the hologram memory medium by having a plurality of reference lines that are parallel to one another and connecting the ends of each reference lines with the start portions of the following reference lines.

5. The method as claimed in claim 4, wherein the information recorded on the data area of the card shaped hologram memory medium is sequentially recorded from an opened end of a reference line to an opened end of another reference line.

6. The method as claimed in claim 1, wherein a recording shape adjacent to a portion of converting a recording direction is a curve.

7. The method as claimed in claim 1, wherein the information is recorded on the data area of the hologram memory medium by a two-dimensional shift multi-recording technique.

8. The method as claimed in claim 2, wherein the information is recorded on the data area of the hologram memory medium by a two-dimensional shift multi-recording technique, and the distance between the parallel reference lines, which are formed in a spiral shape, is the same as a shift amount of the two-dimensional shift multi-recording technique.

9. The method as claimed in claim 4, wherein the information is recorded on the data area of the hologram memory medium by a two-dimensional shift multi-recording technique, and the distance between the parallel reference lines is the same as a shift amount of a two-dimensional shift multi-recording technique.

10. A method comprising:
obtaining a hologram memory medium having a data area for storing information; and
sequentially recording the information, in the form of interference fringes, on the data area of the hologram memory medium along a predetermined route that spans the entire data area of the hologram memory medium, such that the information is recorded on the data area of the hologram memory medium continuously without operation interruption.

11. The method as claimed in claim 10, wherein the predetermined route is formed in a spiral shape.

12. The method as claimed in claim 11, wherein the information recorded on the data area of the hologram memory medium, is sequentially recorded from a central location extending to a peripheral location in the data area of the hologram memory medium in a spiral shape, or alternatively, from the peripheral location extending to the central location in the data area of the hologram memory medium in the spiral shape.

13. The method as claimed in claim 10, wherein the predetermined route is formed in a continuous zig-zag shape by having a plurality of reference lines that are parallel to one another and connecting an end of each reference line with a beginning of a following reference line.

14. The method as claimed in claim 10, wherein the information is recorded on the data area of the hologram memory medium by a two-dimensional shift multi-recording technique.

15. The method as claims in claim 11, wherein the information is recorded on the data area of the hologram memory medium by a two-dimensional shift multi-recording technique, and a distance between parallel reference lines which are formed in a spiral shape, is the same as a shift amount of the two-dimensional shift multi-recording technique.

16. The method as claims in claim 13, wherein the information is recorded on the data area of the hologram memory medium by a two-dimensional shift multi-recording technique, and a distance between parallel reference lines is the same as a shift amount of the two-dimensional shift multi-recording technique.

17. The method as claimed in claim 10, wherein the hologram memory medium comprises:
a pair of substrates; and
a hologram recording layer disposed between the pair of substrates, for recording information in the form of interference fringes,
wherein one substrate is provided with a series of pits in a concave or convex shape for storing servo information needed for recording information.

18. The method as claimed in claim 10, further comprising:
sequentially reproducing information recorded in the form of interference fringes, on the data area of the hologram memory medium, along a predetermined route that spans the entire data area of the hologram memory medium, such that the information is reproduced from the data area of the hologram memory medium continuously without operation interruption.

19. An apparatus comprising:
a hologram memory medium;
a recording/reproducing unit arranged to sequentially record information on a data area of the hologram memory medium, in the form of interference fringes along a predetermined route that spans an entire data area of the hologram memory medium, by irradiating an object beam corresponding to information to be recorded and a reference beam onto the hologram memory medium along the predetermined route, and to sequentially reproduce information from the data area of the hologram memory medium by irradiating the reference beam to the interference fringes along the predetermined route; and
a location control unit arranged to control locations of the signal beam and the reference beam irradiated from the data recording/reproducing unit.

20. The apparatus as claimed in claim 19, wherein the hologram memory medium is in a card shape or a rectangular shape.

21. The apparatus as claimed in claims 19, wherein the hologram memory medium comprises:
a pair of substrates; and
a hologram recording/reproducing layer disposed between the pair of substrates, for recording information in the form of interference fringes or enabling playback of such information, wherein one substrate is provided with a series of pits in a concave or convex shape for storing servo information needed for recording/playback of such information.

22. The apparatus as claimed in claim 19, wherein the predetermined route is formed in a spiral shape, and the information recorded on the hologram memory medium is sequentially recorded from a central location extending to a peripheral location in the data area of the hologram memory medium in a spiral shape, or alternatively, from the peripheral location extending to the central location in the data area of the hologram memory medium in the spiral shape.

23. The apparatus as claimed in claim 19, wherein the predetermined route is formed in a continuous zig-zag shape by having a plurality of reference lines that are parallel to one another and connecting an end of each reference line with a beginning of a following reference line.

24. The apparatus as claimed in claim 19, wherein the information is recorded on the data area of the hologram memory medium by a two-dimensional shift multi-recording technique.

25. A hologram memory medium, comprising:
a pair of substrates; and
a hologram recording layer disposed between the pair of substrates, for recording information in the form of interference fringes,
wherein one substrate is provided with a series of pits in a concave or convex shape for storing servo information needed for recording information, and
wherein the information is sequentially recorded, in the form of interference fringes, along a predetermined route continuously without operation interruption.

26. The hologram memory medium as claimed in claim 25, wherein the hologram memory medium is in a card shape or a rectangular shape.

27. The hologram memory medium as claimed in claims 25, wherein the predetermined route is formed in a spiral shape, and the information recorded on the hologram memory medium is sequentially recorded from a central location extending to a peripheral location in the hologram memory medium in a spiral shape, or alternatively, from the peripheral location extending to the central location in the hologram memory medium in the spiral shape.

28. The hologram memory medium as claimed in claim 25, wherein the predetermined route is formed in a continuous zig-zag shape by having a plurality of reference lines representing the interference fringes that are parallel to one another and connecting an end of each reference line with a beginning of a following reference line on the hologram memory medium.

29. The hologram memory medium as claimed in claim 27, wherein the information is recorded on the hologram memory medium by a two-dimensional shift multi-recording technique.

30. The hologram memory medium as claimed in claim 28, wherein the information is recorded on the hologram memory medium by a two-dimensional shift multi-recording technique.
